(19) United States
(12) Patent Application Publication
(10) Pub. No.: US 2007/0083494 A1
(43) Pub. Date: Apr. 12, 2007

(54) Application of an electronic prescription object to food preparation

(76) Inventors: Michael P. Carlson, Austin, TX (US); Linda A. Lisle, Cedar Park, TX (US); Herman Rodriguez, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/246,787

(22) Filed: Oct. 7, 2005

(51) Int. Cl. G06F 17/30

(52) U.S. Cl. 707/3

(57) ABSTRACT

A method, program product, and system for application of an electronic prescription object to food preparation. In an exemplary embodiment, the method includes accessing a prescription object. Further, communications are established between the prescription object and an information repository by use of at least one of a communication network or a server provided by the information repository. Prescription object data is sent to the information repository. The information repository searches for information in response to the prescription object data sent to the information repository by the prescription object. Search information is related to at least one of food preparation or drug and food interactions. Search results are sent to the prescription object from the information repository.

### FIELD OF THE INVENTION

The present invention generally relates to the field of communications, and more particularly to a method and a system for providing customized food preparation information to an individual with special dietary or medical concerns.

### BACKGROUND OF THE INVENTION

As the number of prescriptions and over-the-counter drugs available to consumers continues to increase, so does the possibility of a user experiencing undesired effects caused by multiple drug interactions or drug-food interactions. Currently, individuals often receive prescriptions or dietary restrictions from their physicians. However, instructions which accompany the prescriptions are often cumbersome to read or difficult to understand. Further, such instructions may be incomplete in regards to possible undesirable food and drug interactions. Moreover, even if the instructions are complete, they do not assist a patient in determining where to purchase food in compliance with the specific drug regime or ideas of what food to prepare. For example, a border-line diabetic may be put on a restricted diet by his or her physician. While dietary guidelines may be provided to the patient, places to purchase compliant food, how to prepare such food, or which foods contain substances which must be avoided are often not provided. Such dilemma often leaves the patient frustrated, confused and may lead to non-compliance or not obtaining the optimal benefit from the drug.

The possibility of multiple drug interactions or drug-food interactions is further compounded by the increased use of herbal remedies such as nutriceuticals in addition to prescribed medications to treat various ailments. Often patients do not mention the use of herbal remedies to their physicians for they do not regard such compounds as drugs and thus, do not see the potential for multiple drug interactions or they believe their physician will not be receptive to the use of the alternative compounds. Therefore, such drug interactions are often not discovered prior to their occurrence.

Therefore, it would be desirable to provide a method and system which may address the aforementioned problems.

### SUMMARY OF THE INVENTION

In a first aspect of the invention, a method for application of an electronic prescription object to food preparation is provided. In the present aspect, the method includes accessing a prescription object. Further, communications are established between the prescription object and an information repository by use of a communication network or a server provided by the information repository. Prescription object data is sent to the information repository by the prescription object. The information repository searches for information in response to the data sent to the information repository by the prescription object. Search information is related to at least one of food preparation or drug and food interactions. Search results are sent to the prescription object from the information repository.

In a further aspect of the present invention, a computer program product including a computer useable medium having computer usable program code for application of an electronic prescription object to food preparation is disclosed. In accordance with an exemplary aspect, the computer program product includes computer usable program code for accessing a prescription object. Further, computer usable program code for establishing communications between the prescription object and an information repository is included. Establishment of communications may include use of a communication network or a server provided by the information repository. The product also includes computer usable program code for sending prescription object data to the information repository. Moreover, computer usable program code for searching by the information repository for information in response to the prescription object data is included. Search information may be related to at least one of food preparation or drug and food interactions. Additionally, computer usable program code for sending search results to the prescription object from the information repository is provided.

In an additional aspect of the present invention, a system for application of an electronic prescription object to food preparation is provided. In accordance with an exemplary aspect, the system includes an electronic device including a prescription object for assisting with food preparation, the electronic prescription object including data related to at least one of a medical prescription or dietary regime. Further, at least one information repository server is communicatively coupled to the electronic device and thus, the prescription object. In the present aspect, the information repository server may be an on-line food service provider including information regarding at least one of food selection at a grocery store, food selection at a restaurant, or food preparation. The electronic prescription object provides data related to the at least one of the medical prescription or dietary regime to the at least one information repository server so that such server may provide the electronic prescription object with food data related to the at least one of the medical prescription or dietary regime.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method for setting-up a prescription object to assist with food preparation in accordance with an exemplary embodiment of the present invention;

FIG. 2 is a flow diagram illustrating a method for application of an electronic prescription object to food preparation in accordance with an exemplary embodiment of the present invention, wherein the prescription object sends information to a information repository to obtain information regarding food preparation; and

FIG. 3 is a block diagram illustrating a system for application of a device including a prescription object to food preparation in accordance with an exemplary embodiment of the present invention, wherein a first device including the prescription object communicates with a second device via a communication network.

### DETAILED DESCRIPTION OF THE INVENTION

Reference will now be made in detail to the presently preferred embodiments of the invention, examples of which are illustrated in the accompanying drawings.

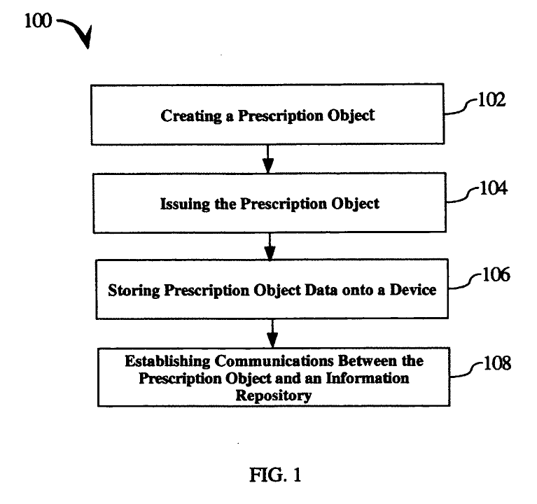

Referring to FIG. 1, a method 100 of setting-up a prescription object for application of such object to food preparation is provided. In an embodiment, the method 100 includes creating the prescription object 102. The creation of the prescription object 102 may include imputing prescription details. For example, prescription details such as the dosage of medication, type of medication, reason for medication, strength of medication, number of refills for medication, chemical composition of medication, side-effects of medication, and expiration date of medication may be imputed into the electronic prescription object. Further, other details such as name, social security number, insurance information or other personal data may be included within the prescription object. In addition, information regarding patient dietary restrictions may be stored within the prescription object. For instance, a notation such as “restrict carbohydrate, fat, and sugar intake” may be included to denote that such substances should be avoided by the patient. Moreover, information about a patient allergy or other drug and food interactions which may be beneficial or detrimental to the actions of the medication may be provided. In addition, the expiration date of the prescription object may be included. For example, accessibility of the prescription object expires twelve months from the date of issuance. Alternatively, the prescription object's expiration date may the same date as the prescription's expiration date. Such feature allows a service provider such as a pharmacy to up-date the prescription object at the same time as the prescription.

As illustrated in FIG. 1, the prescription object is issued 104 by a physician or other accredited agency. The issuance of such object by such entities provides for the content of the prescription object to be monitored and controlled in accordance with such entities guidelines. In additional embodiments, issuing of the prescription object 104 includes securing the prescription object by imputing encryption code protecting the prescription object from unauthorized entry. For example, the prescription object may be encrypted with a private key of an accredited agency. Further, the prescription object may be protected from unauthorized copying using digital rights management (DRM) control. The patient (e.g., receiving party of the prescription object) may use a public key of the accreditation agency to open the contents of the prescription object. The contents (e.g., data) of the prescription object may then be stored onto a device 106. For example, data may be stored on a personal computer, personal digital assistant, cellular telephone, a laptop computer, a smart card, and the like. A user may then recall the prescription object data on such device as needed (e.g., dining at a restaurant, grocery shopping, and the like). The ability to transfer the contents of the prescription object onto a mobile device allows the user to access the information while in transit. In addition, the method 100 includes establishing communications between the prescription object and an information repository 108. Establishment may include use of a communication network (e.g., a wireless communication network) and a server provided by the information repository.

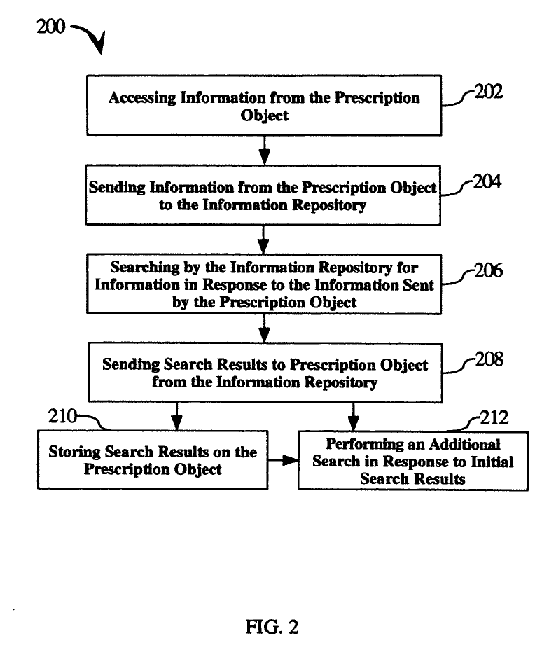

Referring to FIG. 2, a method 200 for applying a prescription object to food preparation is provided. The method 200 includes accessing a prescription object 202. Accessing the prescription object may include retrieving various types of information from the object such as prescription details, patient dietary restrictions, and the like. The method further includes sending the prescription object data to the information repository 204. For instance, prescription details such as type of medication, strength of medication, dietary restrictions, side effects, and chemical composition are sent from the prescription object to the server provided by the information repository. The information repository searches for information in response to the data sent to the information repository by the prescription object 208. Search information is related to at least one of food preparation or drug and food interaction. For example, the server provides a database of foods, recipes, drug compositions, and the positive and negative effects associated with ingestion of such foods and drug compositions. Further, the server may perform a database query for a best match in which the benefits as well as the counter-productive results of a food with a specified medication or diet regime are identified. In a further example, the prescription object may be queried against a repository such as a national or local grocery store or a restaurant menu using wireless communications with a server provided by the establishment. In such example, a user may type in the query “list groceries or items that do not interact negatively with prescription object x (e.g., x being the name of the prescription object).” Generated search results are sent from the information repository to the prescription object 210. Search results may be used by the requestor to perform grocery shopping, assist in selecting an entree at a restaurant, preparing a meal at home, and the like.

As illustrated in FIG. 2, additional steps may be taken following the sending of the search results from the information repository to the prescription object 210. For example, search results may be stored within the prescription object 212 or onto a device such as a personal computer, laptop, personal digital assistant, cellular phone allowing for subsequent review of the search results. Further, stored results on a mobile device allows a user to access such results while in transit. For example, stored results such as a grocery store list on a personal digital assistant may be accessed upon arriving at the grocery store to assist the user in purchasing groceries. Further, such stored results may assist a user in selecting a recipe for preparing a meal or making a menu selection at a restaurant.

In additional embodiments, in response to the initial search results, an additional search may be performed 214. For example, an initial search may include the query of “list of food which does not interact negatively with prescription object x” (e.g., x being the name of the prescription object). Initial search results may include “oranges, apples, chicken, fish including salmon, cod, and shrimp.” A user may perform an additional search in response to this initial query. For example, the additional search may be “list of grocery stores which carry cod.” The additional search feature allows a user to have multiple user specific interactions with various information repositories allowing a user to narrow further the types of food related information. It is contemplated that a user may perform multiple searches in response to an initial search. For example, a user may perform searches narrowing the results until the desired information is obtained.

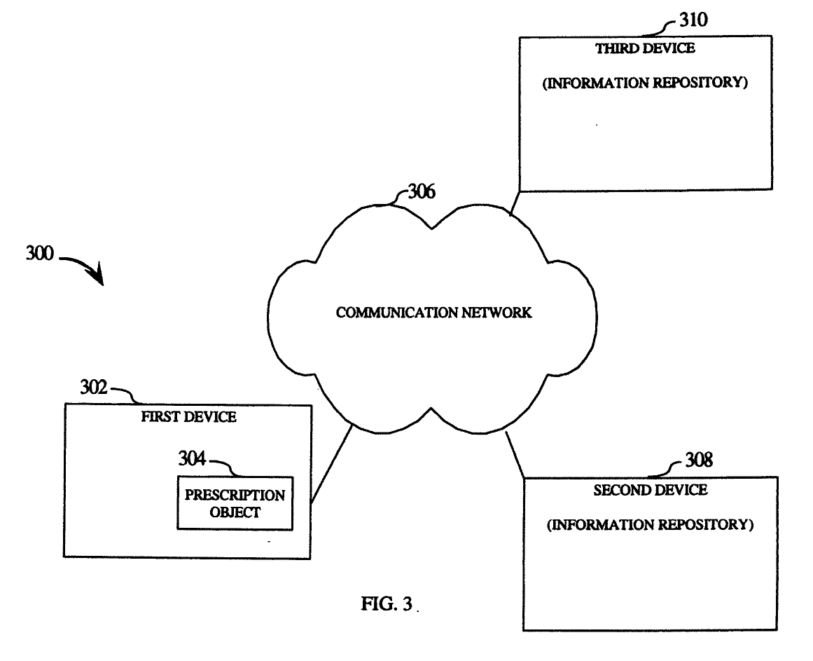

Referring to FIG. 3, a system 300 for application of an electronic prescription object to food preparation in accordance with an exemplary embodiment of the present invention is provided. The system 300 includes a first device 302 with a prescription object 304. The first device 302 may be an electronic device such as a personal computer, laptop computer or the like which includes a prescription object 304. The prescription object 304 may be used to store information for a user regarding a prescription, dietary regime, medical condition, and the like. Further, the prescription object 304 is capable of communicating with various devices such as an information repository server via the communication network 306. For example, as illustrated in FIG. 3, a user may send his or her prescription or dietary regime details to a second device 308 including an information repository server such as a server maintained by an online grocery store information provider. The server then searches its database for information in accordance with the specific prescription or dietary regime. It is further contemplated that the prescription object 304 may communicate with multiple servers. As illustrated in FIG. 3, a user may first utilize the Internet to access a website maintained by a healthcare provider or the like to obtain a list of foods that are compatible with his or her prescription or dietary regime. Next, such search results may be utilized by the user to access an additional server (e.g., a third device 310) such as one maintained by a local or national grocery store to obtain information regarding food selection. An additional search may be performed to access an online recipe provider which provides recipes in accordance with compatible foods. Search results by the server may be communicated to the prescription object by the communication network 306. It is contemplated that the search results may be stored within the prescription object 304 allowing for subsequent retrieval or on an additional device such as a personal computer, laptop computer, personal digital assistant, cellular phone, and the like for retrieval of the results while in transit or without access to the prescription object.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, and the like) may be coupled to the system either directly or through intervening I/O controllers.

Network adapters may also be coupled to the system to enable the data processing system to become coupled to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method, comprising steps of:
accessing a prescription object;
establishing communications between the prescription object and an information repository;
sending prescription object data to the information repository;
searching by the information repository for information in response to the prescription object data sent to the information repository by the prescription object, search information related to at least one of food preparation or drug and food interactions; and
sending search results to the prescription object from the information repository.

2. The method as claimed in claim 1, wherein the accessing step includes retrieving prescription details.

3. The method as claimed in claim 2, wherein the prescription details are selected from the group consisting of dosage of medication, type of medication, reason for medication, strength of medication, number of refills for medication, chemical composition of medication, side-effects of medication, and expiration date of medication.

4. The method as claimed in claim 1, wherein the accessing step includes retrieving information regarding patient dietary restrictions.

5. The method as claimed in claim 1, wherein the establishing communications between the prescription object and the information repository is by using at least one of a wireless communication network or a server provided by the information repository.

6. The method as claimed in claim 1, further comprising a step of storing the prescription object data onto a device, the device being at least one of a personal computer, a laptop computer, a personal digital assistant, or a cellular telephone.

7. The method as claimed in claim 1, wherein the information repository is an on-line food service provider including information regarding at least one of food selection at a grocery store, food selection at a restaurant, or food preparation.

8. The method as claimed in claim 1, further comprising a step of storing the search results on the prescription object for subsequent review.

9. The method as claimed in claim 1, further comprising a step of performing an additional search in response to the results generated from initial search.

10. A computer program product comprising:
a computer useable medium including computer usable program code for application of an electronic prescription object to food preparation, the computer program product including:
computer usable program code for accessing a prescription object;
computer usable program code for establishing communications between the prescription object;
computer usable program code for sending prescription object data to the information repository;
computer usable program code for searching by the information repository for information in response to the prescription object data sent to the information repository by the prescription object, search information related to at least one of food preparation or drug and food interactions; and
computer usable program code for sending search results to the prescription object from the information repository.

11. The computer program product as claimed in claim 10, wherein the computer usable program code for accessing the prescription object includes retrieving at least one of prescription details or dietary restrictions.

12. The computer program product as claimed in claim 11, wherein the prescription details are selected from the group consisting of dosage of medication, type of medication, reason for medication, strength of medication, number of refills for medication, chemical composition of medication, side-effects of medication, and expiration date of medication.

13. The computer program product as claimed in claim 10, wherein the computer usable program code for establishing communications between the prescription object and the information repository uses at least one of a wireless communication network or a server provided by the information repository.

14. The computer program product as claimed in claim 10, further comprising computer usable program code for storing the prescription object data onto a device, the device being at least one of a personal computer, a laptop computer, a personal digital assistant, or a cellular telephone.

15. The computer program product as claimed in claim 10, wherein the information repository is an on-line food service provider including information regarding at least one of food selection at a grocery store, food selection at a restaurant, or food preparation.

16. The computer program product as claimed in claim 10, further comprising computer usable program code for storing the search results on the prescription object for subsequent review.

17. The computer program product as claimed in claim 10, further comprising computer usable program code for performing an additional search in response to the results generated from initial search.

18. A system for application of an electronic prescription object to food preparation, comprising:
a electronic device including a prescription object for assisting with food preparation, the prescription object including data related to at least one of a medical prescription, medical condition, or dietary regime; and
at least one information repository server communicatively coupled to the electronic device,
wherein the prescription object provides data related to the at least one of the medical prescription, medical condition, or dietary regime to the at least one information repository server so that such server may provide the prescription object with food data related to the at least one of the medical prescription, medical condition or dietary regime.

19. The system for application of an electronic prescription object to food preparation as claimed in claim 18, wherein the at least one information repository server is communicatively coupled with the electronic device via a wireless communication network.

20. The system for application of an electronic prescription object to food preparation as claimed in claim 18, wherein the information repository server is an on-line food service provider including information regarding at least one of food selection at a grocery store, food selection at a restaurant, or food preparation.
